(19) United States
(12) Patent Application Publication
(10) Pub. No.: US 2017/0200315 A1
(43) Pub. Date: Jul. 13, 2017

(54) LIVE STEREOSCOPIC PANORAMIC VIRTUAL REALITY STREAMING SYSTEM

(71) Applicant: Brendan Lockhart, North Hollywood, CA (US)

(72) Inventor: Brendan Lockhart, North Hollywood, CA (US)

(21) Appl. No.: 15/331,687

(22) Filed: Oct. 21, 2016

Related U.S. Application Data
(60) Provisional application No. 62/276,123, filed on Jan. 7, 2016.

(51) Int. Cl. G06T 19/00; H04N 13/02; H04N 5/232

(52) U.S. Cl. CPC G06T 19/006; H04N 5/23238; H04N 13/0239

(57) ABSTRACT

Methods and apparatuses for transmitting and displaying a live, streaming video on a virtual reality headset are disclosed. For example, one method includes receiving, via a transceiver, a foreground portion, or a first subset, of a live video feed at a first frame rate from each camera of the at least one stereoscopic pair of cameras, wherein the foreground portion comprises a first portion of a scene captured by each camera. The method further includes receiving, via the transceiver, a background portion, or a second subset, of the live video feed at a second frame rate from each camera, wherein the background portion comprises a second portion of the scene. The method further includes storing the background portion in a memory. The method further includes combining the received foreground portion with the stored background portion to create a combined video frame. The method further includes displaying at least a portion of the combined video frame on the virtual reality display.

### CLAIM OF PRIORITY UNDER 35 U.S.C. §119

The present Application for Patent claims priority to Provisional Application No. 62/276,123 entitled “LIVE STEREOSCOPIC PANORAMIC VIRTUAL REALITY STREAMING SYSTEM” filed Jan. 7, 2016. Provisional Application No. 62/276,123 is hereby expressly incorporated by reference herein.

### FIELD

The present invention generally relates to systems and methods for reducing bandwidth required for the live streaming of virtual or augmented reality environments to a virtual reality system.

### BACKGROUND

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality (VR) scenario typically involves presentation of digital or virtual image information without transparency to other actual real-world visual input. An augmented reality (AR) scenario typically involves presentation of digital or virtual image information as an augmentation to visualization of the actual world around the user. Both of the VR and AR systems may include devices for transmitting and receiving live stream broadcasts of virtual content for display on the system. The quality of the display of virtual content may depend on the bandwidth of the connection.

Stereoscopic, also known as 3D motion pictures are frequently used in head-mounted displays capable of rendering stereoscopic content. Users may want to view live video feeds and interact with the captured actor(s) via text, audio, and/or video either monoscopically or stereoscopically. Furthermore, users may want to see the actors' environment as doing so may significantly increase the sensation of immersion experienced by the user.

Displaying live content to a user wearing a virtual reality device in a monoscopic format serves as a limitation to their enjoyment of the content, and may cause the user discomfort if the subject(s) being captured are close to the camera. Furthermore, streaming a video that covers 360 azimuthal degrees comes at either the limitation of pixel density, which will cause the displayed subject(s) to appear to the user with limited resolution and/or will utilize a very large amount network bandwidth.

Bandwidth is capacity of a transmit-receive connection, and may also be referred to as the speed of the connection. Broadcasting live video and audio generally requires a connection with broad bandwidth, or high speed. Low bandwidth may cause disruptions or a reduction in quality of the audio and video of the virtual content. Common causes of low bandwidth are a slow internet connection provided by an internet service provider (ISP), or crowded use of the transmit-receive connection. Therefore, reducing the bandwidth required for transmitting and receiving live stream broadcasts of virtual content for display on VR and AR systems is necessary. The systems and techniques described herein are configured to address these challenges.

### SUMMARY

A summary of sample aspects of the disclosure follows. For convenience, one or more aspects of the disclosure may be referred to herein simply as “some aspects.”

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly.

One innovation includes a method for displaying live video on a virtual reality display. The method may include receiving, via a transceiver, a first subset of a video data signal at a first frame rate from a video data transmitter, wherein the first subset comprises a first portion of a scene captured by at least one stereoscopic pair of cameras. The method may include receiving, via the transceiver, a second subset of the video data signal at a second frame rate from the video data transmitter, wherein the second subset comprises a second portion of the scene. The method may include combining, via a first processor, the first subset with the second subset to create a combined video frame. The method may include displaying at least a portion of the combined video frame on the virtual reality display.

For some embodiments, the method may include the video data transmitter, the video data transmitter including capturing, via the at least one stereoscopic pair of cameras, a scene. In some embodiments, the method may include generating, via a second processor, the video data signal, wherein the video data signal comprises the captured scene. In some embodiments, the method may include generating, via the second processor, the first subset and the second subset by separating regions of pixels of the video data signal. In some embodiments, the method may include transmitting the first subset at a first frame rate and transmitting the second subset at a second frame rate.

For some embodiments, the method may include receiving a third subset of pixels, the third subset of pixels being a region of pixels including pixels from both the first subset and the second subset, wherein the region of pixels comprises at least a number of pixels of the first subset and the second subset that are directly adjacent, and wherein the third subset of pixels are received at the first frame rate. In some embodiments, the identified portion of the scene is determined based on at least one of: (i) manual selection of a portion of the scene being captured by each camera of the stereoscopic pair of cameras, and (ii) a motion detection algorithm. In some embodiments, the method may include combining the first subset with the second subset such that the second set of pixels of the surrounding region overlay an identical set of pixels in the second subset. In some embodiments, the method may include determining a difference in image parameters between the first subset and the second subset. In some embodiments, the method may include comparing the image parameters of the first subset with the second subset. In some embodiments, the method may include adjusting the second frame rate when the difference in the image parameters are greater than a threshold value.

For some embodiments, the image parameters comprise at least one of a brightness of the image, a contrast of the image, a sharpness of the image, and a color of the image, wherein the color comprises a hue, shade, tint, and a luminosity value. In some embodiments, the method may include adjusting the second frame rate is user configurable.

One innovation includes a system for displaying live video on a virtual reality display, comprising a transceiver. In some embodiments, the system may include a first processor configured to receive, via the transceiver, a first subset of a video data signal at a first frame rate from a video data transmitter, wherein the first subset comprises a first portion of a scene captured by at least one stereoscopic pair of cameras. In some embodiments, the system may include receiving, via the transceiver, a second subset of the video data signal at a second frame rate from the video data transmitter, wherein the second subset comprises a second portion of the scene. In some embodiments, the system may include storing the second subset in a memory. In some embodiments, the system may include combining the first subset with the second subset to create a combined video frame, and a stereoscopic display operably coupled to the processor and configured to display at least a portion of the combined video frame.

For some embodiments the system may further comprise the video data transmitter, the video data transmitter including, a stereoscopic pair of cameras configured to capture a scene, a second processor configured to generate the video data signal, wherein the video data signal comprises the captured scene, generate the first subset and the second subset by separating regions of pixels of the video data signal, and a transmitter configured to transmit the first subset at a first frame rate, and transmit the second subset at a second frame rate.

For some embodiments, the first subset comprises at least one of an identified portion of a scene and a surrounding region, wherein the identified portion of the scene comprises a first set of pixels, and wherein the surrounding region comprises a second set of pixels, the second set of pixels situated adjacent to the first set of pixels and surrounding the first set of pixels. In some embodiments, the identified portion of the scene is determined based on at least one of manual selection of a portion of the scene being captured by each camera of the stereoscopic pair of cameras, and a motion detection algorithm.

Some embodiments may include combining the first subset with the second subset such that the second set of pixels of the surrounding region overlay an identical set of pixels in the second subset. In some embodiments, the system may include determining a difference in image parameters between the first subset and the second subset, comparing the image parameters of the first subset with the second subset, and adjusting the second frame rate when the difference in the image parameters are greater than a threshold value.

For some embodiments, the image parameters may comprise at least one of a brightness of the image, a contrast of the image, a sharpness of the image, and a color of the image, wherein the color comprises a hue, shade, tint, and a luminosity value. In some embodiments, adjusting the second frame rate is user configurable.

One innovation includes, a non-transitory, computer readable medium comprising instructions that when executed cause a processor in a device to receive, via a transceiver, a first subset of a video data signal at a first frame rate from a video data transmitter, wherein the first subset comprises a first portion of a scene captured by at least one stereoscopic pair of cameras, receive, via the transceiver, a second subset of the video data signal at a second frame rate from the video data transmitter, wherein the second subset comprises a second portion of the scene, combine the first subset with the second subset to create a combined video frame, and display, via a stereoscopic display operably coupled to the processor, at least a portion of the combined video frame.

In some embodiments, the computer readable medium includes the video data transmitter, the video data transmitter comprising a stereoscopic pair of cameras configured to capture a scene, a second processor configured to, generate the video data signal, wherein the video data signal comprises the captured scene, generate the first subset and the second subset by separating regions of pixels of the video data signal, and a transmitter configured to transmit the first subset at a first frame rate, and transmit the second subset at a second frame rate.

In some embodiments, the first subset comprises at least one of an identified portion of a scene and a surrounding region, wherein the identified portion of the scene comprises a first set of pixels, and wherein the surrounding region comprises a second set of pixels, the second set of pixels situated adjacent to the first set of pixels and surrounding the first set of pixels.

### BRIEF DESCRIPTION OF THE DRAWINGS

FIG. 1A is an illustration of an example scene and implementation of a live stereoscopic virtual reality.

FIG. 1B is an illustration of an example stereoscopic camera and virtual reality display.

FIG. 2 is an illustration of an example configuration of a stereoscopic camera structure.

FIG. 3 is an illustration of an example configuration of a 360 degree stereoscopic camera structure.

FIG. 4 is an example of a system for segmenting stereoscopic video data into a foreground video portion and a background video portion.

FIG. 5 illustrates a flow chart for transmitting a foreground portion and a background portion of a video.

FIG. 6 is an example system for multiple portions of a segmented stereoscopic video and combining the portions for display on a virtual reality display.

FIG. 7 illustrates a flow chart for receiving a foreground data signal and a background data signal of a video, and combining the data for displaying the video on a virtual reality display.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different digital imaging technologies, virtual reality system configurations, and image and video processing, some of which are illustrated by way of example in the figures and in the following description. The detailed description and drawings are merely illustrative of the disclosure rather than limiting, the scope of the disclosure being defined by the appended claims and equivalents thereof.

A method of embodiments of the invention includes receiving, from a transmitting device, a number of video data signals at a receiving device coupled to the transmitting device, wherein a first video data signal of a plurality of video data signals is designated to be displayed as a background video and one or more other video data signals of the plurality of video data signals are designated to be displayed as one or more foreground videos. The method further includes merging the background video and the foreground video into a final video image capable of being displayed on a single screen utilizing a virtual reality device. Further details are discussed throughout this document.

As used herein, “network” or “communication network” mean an interconnection network to deliver digital media content (including music, audio/video, gaming, photos, and others) between devices using any number of technologies, such as Serial Advanced Technology Attachment (SATA), Frame Information Structure (FIS), etc. A network may include a personal entertainment network, such as a network in a household, a network in a business setting, or any other network of devices and/or components. A network may include a Local Area Network (LAN), Wide Area Network (WAN), Metropolitan Area Network (MAN), intranet, the Internet, etc. In a network, certain network devices may be a source of media content, such as a digital television tuner, cable set-top box, handheld device (e.g., personal device assistant (PDA)), video storage server, and other source device. Other devices may display or use media content, such as a digital television, home theater system, audio system, gaming system, and other devices. Further, certain devices may be intended to store or transfer media content, such as video and audio storage servers. Certain devices may perform multiple media functions, such as cable set-top box can serve as a receiver device (receiving information from a cable headend) as well as a transmitter device (transmitting information to a TV) and vice versa. Network devices may be co-located on a single local area network or span over multiple network segments, such as through tunneling between local area networks. A network may also include multiple data encoding and encryption processes as well as identify verification processes, such as unique signature verification and unique identification (ID) comparison. Moreover, an interconnection network may include HDMIs. HDMI refers to an audio-video interface for transmitting uncompressed digital data, and represents a digital alternative to conventional analog standards, such as coaxial cable, radio frequency (RF), component video, etc. HDMI is commonly used to connection various devices, such as set-top boxes, digital video disk (DVD) players, game consoles, computer systems, etc., with televisions, computer monitors, and other display devices. For example, an HDMI can be used to connect a transmitting device to a receiving device and further to other intermediate and/or peripheral devices, such as a separate display device, etc.

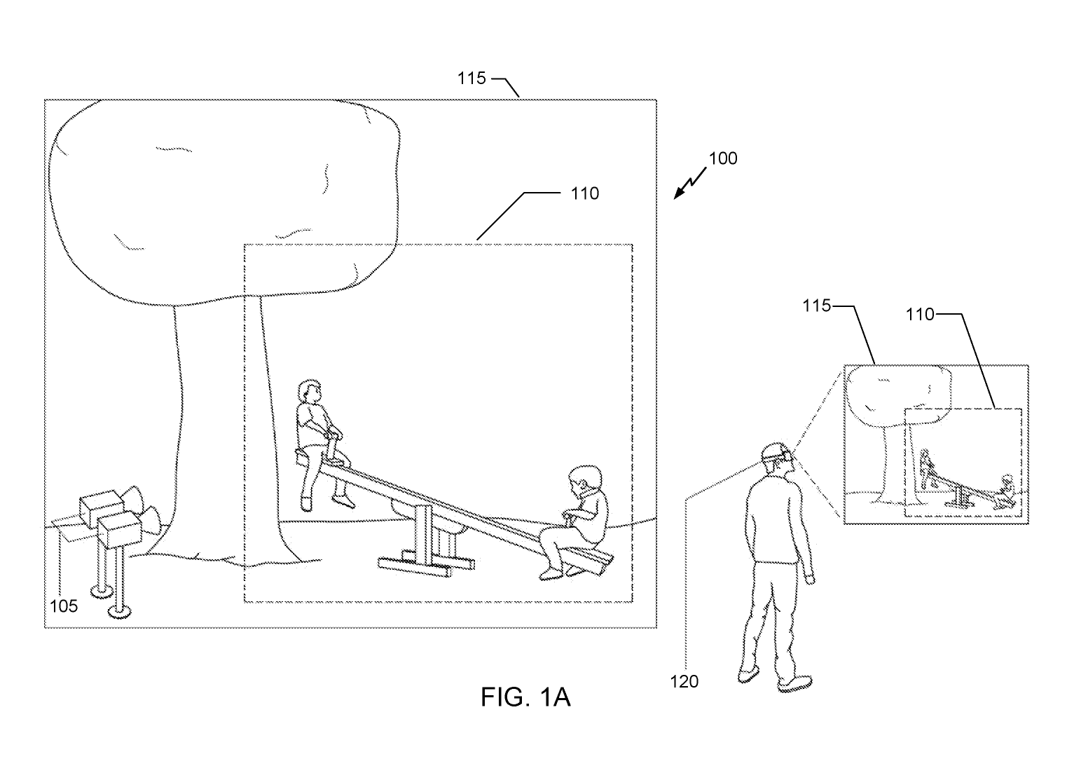

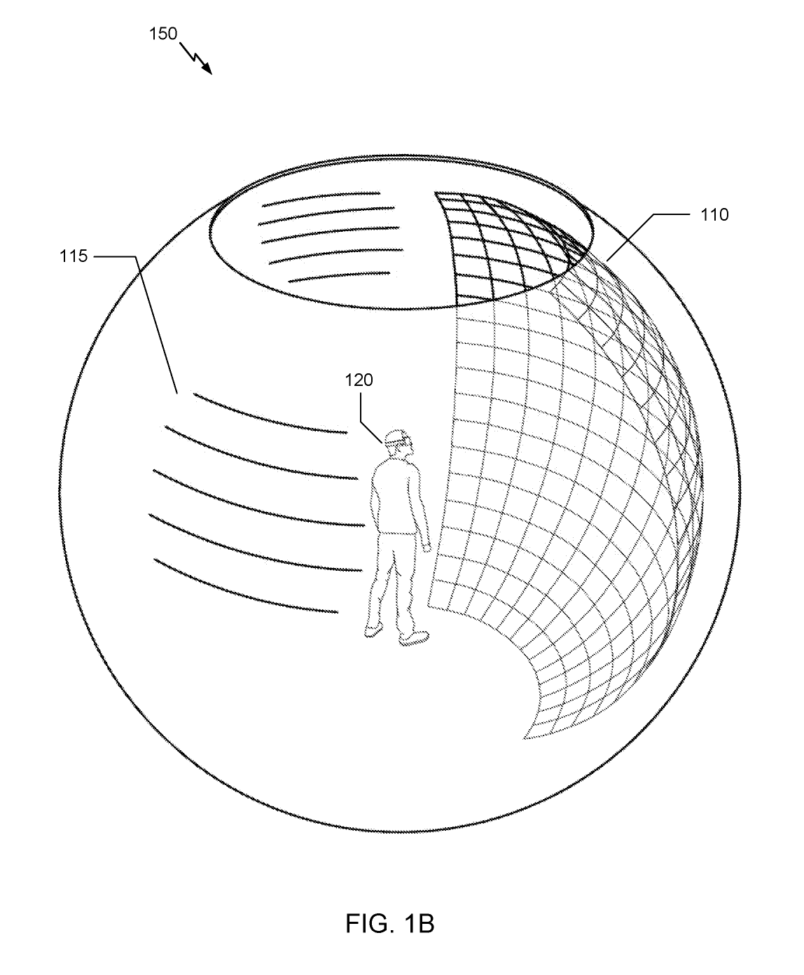

FIG. 1A illustrates an example of a live scene 100 as broadcast to a VR device 120. In one implementation, a stereoscopic pair of cameras may capture a scene 100. The scene 100 may include a background portion 115 and a foreground portion 110. The pair of cameras 105 may be integrated with a data communicator configured to transmit the video data to the VR device 120. While the foreground portion 110 is illustrated as a subset of the entire scene 100, the foreground portion 110 may also include any size portion of the scene 100 up to the entire scene 100.

FIG. 1B illustrates a substantially spherical field of view 150 generated by combining images from a plurality of cameras. In one embodiment, two cameras 105 may be used to create a live, stereoscopic video display 110. The live video display 110 may include video data of two or more video cameras. The video data may include video rendered exclusively to the left and right eyes respectively, thereby creating the illusion of depth. The live video display 110 may be overlaid or interweaved with a panoramic video display 115 to form a panoramic image of up to 360° about any desired axis of rotation. In one embodiment, the plurality of cameras may be in a remote location relative to the virtual reality headset 150 that is displaying the video display 110, the video data generated by the cameras provided to virtual reality headset 150 over a wireless or wired network connection. The plurality of cameras may be manually controlled or controlled via remotely access.

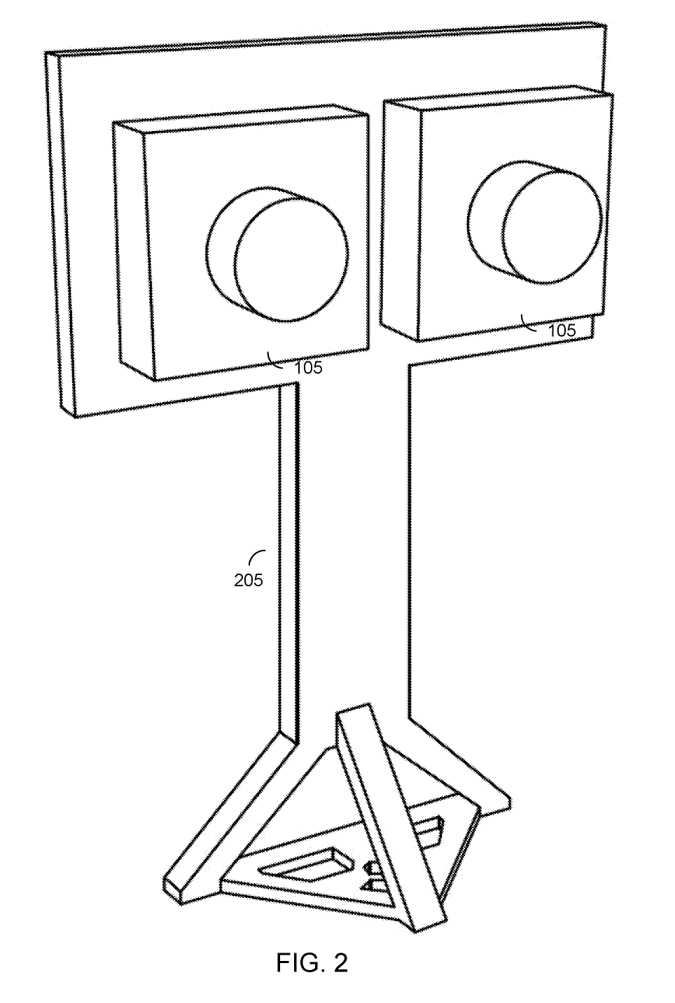

FIG. 2 illustrates an example structure and housing of a two camera 105a-b system. The two cameras may be securely attached to a mount 205. The two cameras 105a-b may be fixed with a distance separating the lens of each camera. This mount may be rotated so that the two cameras 105a-b may capture a panoramic view of the scene 100. The same two cameras 105a-b may also capture the live video.

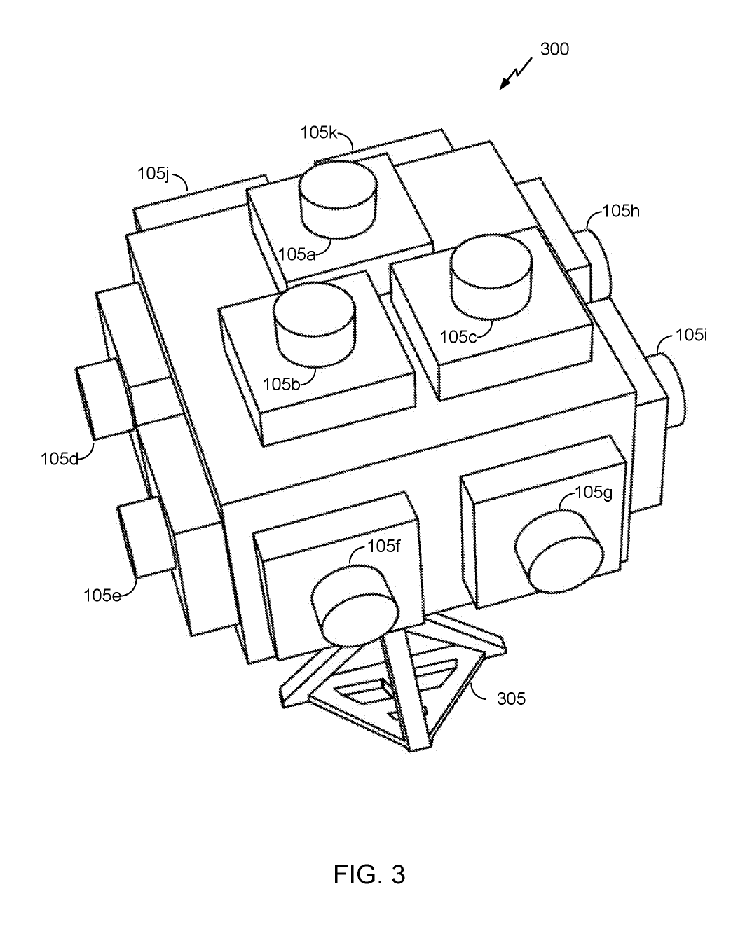

FIG. 3 illustrates an example structure containing a plurality of cameras 105a-k securely mounted to a structure 305. A plurality of cameras 105a-k may be used to capture a panoramic view of the scene 100. In one embodiment, two of the eleven cameras may be used to capture the live video display 110 while the remaining cameras capture the panoramic image surrounding the foreground or live video display 110. The 360-degree panoramic camera system 300 may utilize a processing algorithm to process image signals and blend the images to produce a panoramic scene. The processing algorithm may be included in one or more software executable files encoded onto a computer readable media of a data storage device for execution of the algorithm. The processing algorithm may use known angular relationships of the cameras to vertically and horizontally align images and blend images taken by each camera module.

According to one embodiment, the image signal processor (ISP) 480, 485 processes raw video data and performs a process of pixel correction, image de-bayering, and color correction to produce a processed image or frame. From the pixel correction, the process algorithm also includes scene statistics collection and image adjustments, which are calculated by auto gain/exposure control and auto white balance functions. User input by manual control may be received by the ISP to adjust color, sharpness, brightness, and other image characteristics. The resulting image is then stitched and combined with other images received from the other cameras 115a-k. The process of image blending may smooth the transitions between the received camera images to produce a single panoramic image.

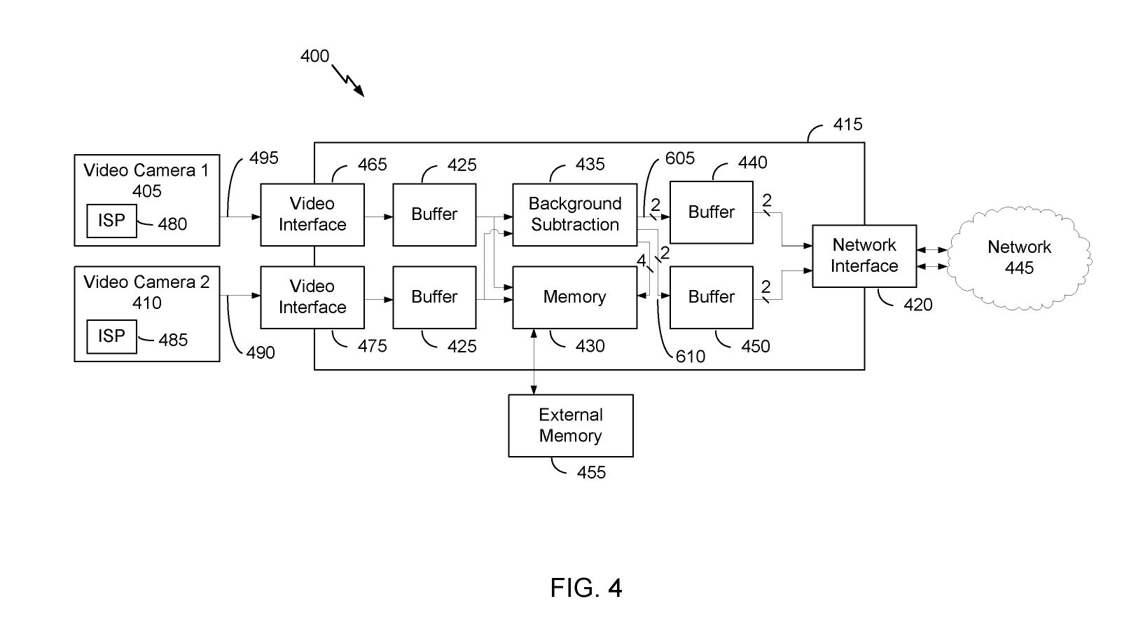

FIG. 4 illustrates an example camera system 400 for capturing and transmitting at least two video data signals 605, 610 via network 445 communication. The system may include a set of two or more video cameras 405, 410 forming a stereoscopic pair for recording a video of a live event. The video cameras may be any set of cameras illustrated in FIG. 2 and FIG. 3. Such cameras may include stereoscopic digital camera pairs integrated into a single system for capturing high resolution, virtual 360 degree video. Images received on the image sensor of each camera 115a-k may be digitized by the ISP 480, 485 of the camera. In an embodiment that includes more than one set of stereoscopic camera pairs, the digitized images or frames may be stitched together by a processor 415 in the camera system 400, or alternatively, by a processor 615 in the transceiver 600, based upon a spatial relationship between the images. The stitched frames may be used to generate the panoramic video data 115 signal and the live video display 110 displayed in the virtual reality headset 150. In an example embodiment, processor 615 may be the same processor used in the live streaming system 400.

Still referring to FIG. 4, the video cameras 405, 410 may be integrated with a video processor 415 via a video interface for each camera 465, 475. The video interface connects the camera to the processor 415 so that video data 490, 495 may be transmitted from the camera to the processor 415. In some embodiments, the video interface may include a wired connection, for example, HDMI. In an alternative embodiment, the video interface may be a wireless interface, for example, Bluetooth or Wi-Fi.

Still referring to FIG. 4, one or more buffers 425 may be included for video data 490, 495 signals between the video interface 465, 475 and a background subtraction module 435. FIG. 4 illustrates an embodiment that includes two buffers at both the video signal input 490, 495 and video signal output 605, 610, however, other configurations may be used. In a non-limiting example, the buffers 425, 440, 450 may be replaced by a single buffer. In another non-limiting example, the buffers 440, 450 may be supplemented by an additional number of buffers to support additional cameras. The buffer 425 may be implemented as a temporary holding place for the received video data 490, 495 to control the rate at which the video data 490, 495 is delivered to the background subtraction module 435 or to an internal memory 430 and an external memory 455. The external memory unit 455 may be included to store instructions for video background subtraction and for storing frames of both the pre-processed video data and the post processed video data signals. The external memory unit 455 may also store information regarding the resolution of the camera system, the frame rate associated with the video data received by the video interface 465, 475, the number of cameras used, etc. In one embodiment, the external memory 455 may be a fixed piece of hardware such as a random access memory (RAM) chip, a read-only memory, and a flash memory. In another embodiment, the external memory 455 may include a removable memory device, for example, a memory card and a USB drive. The processor 415 may include an additional memory, or “internal memory” 430 integrated with the processor hardware and directly accessibly by the processor 415. The internal memory 430 may be a random access memory (RAM) chip, a read-only memory, or a flash memory, and may contain instructions for the processor 415 to interface with the network 445 and the external memory 455.

Still referring to FIG. 4, a series of buffers 440, 450 may be integrated into the video processor 415 for temporarily storing the post processed video signals 605, 610 before transmitting them into the network 445. The buffers 440, 450 may control the frame rate, or speed at which the frames are transmitted. The buffers 440, 450 may be integrated with a network interface 420 for transmitting the post processed video feeds 605, 610 into the network 445. The network interface 420 may include a wired interface, a wireless interface (e.g., wireless transceiver or transmitter), or both. Although the network interface is illustrated as accepting and transmitting a pair of data signals to the network 445, the pair of data signals may be combined into one signal by the processor 415 before being transmitted to the network.

Still referring to FIG. 4, the video processor 415 may include the background subtraction module 435 comprising an algorithm for segmenting, portioning, or separating, a background of a video frame from the foreground of the video frame. The background subtraction module 435 may generate two post processed video data signals 605, 610 from each camera of the stereoscopic video cameras 405, 410. The first video data signal 605 may be designated as a background video. The background video may include a substantial portion of the panoramic data 115. For example, the first video data signal 605 may include between 50% and 100% of the panoramic video display data. The second video data signal 610 may be designated as data for a foreground video. The foreground video may include a substantial portion of the live video display 110. For example, the second video data signal 605 may include between 50% and 100% of the live video display 110. It should be noted that the plurality of cameras may share one or more of the components illustrated in FIG. 4.

The background subtraction module 435 may use a frame differencing motion detection algorithm to separate the foreground from the background. The motion detection algorithm segments designated or moving objects from the background. The pixels of an image or video frame can be classified into background pixels and foreground pixels using a background subtraction module 435 and segmented into separate video data signals. For example, each frame of the video data signal 495 from the first video camera 405 may be classified by pixel to identify whether the pixel is foreground or background. The background pixels of each frame may be subtracted from the frame and a new video data signal generated using the subtracted background pixels. In an alternative embodiment, the background subtraction model may include classifying pixels as background and/or foreground pixels by detecting foreground pixels using a mathematical process, and subtracting the foreground pixels from the image frame to obtain background pixels. In some embodiments, the foreground detection can be based on detection of motion of a subject. In these embodiments, two successive image frames can be compared to determine, based on a mathematical model, changes in locations of some subjects, and classify subjects that have moved by more than a predetermined distance within the image frame to be foreground pixels. The mathematical models can use, for example, a median or an average value of a histogram. Some other models can use, for example, Gaussian or a mixture of Gaussians or a kernel density estimation. Yet some other models can use, for example, a pixel filtering technique. The mathematical models can use certain features for modeling the background and for detecting the foreground including, for example, spectral features (e.g., color features), spatial features (e.g., edge features, texture features or stereo features), and temporal features (e.g., motion features).

In one example embodiment, a motion detection algorithm may receive a first frame and designate the frame as a background frame received at time t.

P[F(t)]=P[I(t)]−P[B] (1)

where:
t=time;
I(t)=images obtained at time t;
B=background image;
P=pixel value.
   Equation (1) shows a motion detection algorithm that may be employed by the live streaming system 400. The algorithm may begin by separating foreground or moving objects from the background. This can be accomplished by using an initial image as background (denoted by B) and comparing subsequent frames captured at time t+Δt (denoted by I(t)) to compare with the initial background image. A disparity calculation may be used to determine displacement of a foreground object in a scene. The foreground may be segmented and removed from the scene using an image subtraction technique.

In some embodiments of foreground detection, separating foreground pixels from the image frame comprises identifying the foreground subject of the image frame, predicting a movement path of the foreground object, and subtracting pixels corresponding to the foreground subject sweeping through the movement path. Predicting the movement path, for example, can include determining a velocity including the direction and speed based on extrapolation of one or more prior image frames.

In some embodiments of foreground detection, separating foreground pixels from the image frame comprises identifying the foreground subject of the image frame and expanding foreground pixel classification to include pixels that would otherwise be classified as background. In other words, the pixels classified as foreground may be expanded to include an amount of background pixels that surround the foreground subject. The amount of background pixels that are included in the expanded foreground subject may be user configurable, and may also be automatically adjusted based on a number of parameters such as rate of movement of the foreground subject and predicted direction of the foreground subject. In some embodiments, the expanded foreground pixels may be given a third classification, or a third subset, that identifies the pixels as both foreground and background. In such an implementation, the segmentation of a frame into a separate background frame and foreground frame would result in a number of identical pixels shared by the two segmented frames. For example, in one embodiment, the foreground region 110 may include pixels that are directly adjacent to pixels of the background region 115. In such an embodiment, there may be no overlap in the classification of a pixel as being part of the foreground region or the background region. However, in another embodiment, the third classification may identify pixels as both foreground and background, thereby expanding the foreground region 110 to include pixels that are also classified as background region 115 pixels, and expanding the background region 115 to include pixels that are also classified as foreground region 110 pixels. In such a configuration, the pixels classified only as foreground region 110 pixels may not be directly adjacent to pixels classified only as background region 115 pixels, but rather separated by a number of pixels labeled as both background and foreground. Thus, the dashed line in FIG. 1A indicating the boundary between the foreground region 110 and the background region 115 may also indicate a third region, the third region being a set of pixels of the third classification. The size of this region of the third classification of pixels may be a static number of pixels, or may be a dynamically changing number of pixels based on the size of the foreground region 110, the size of the background region 115, or user configuration. In one embodiment, the size of the third region is determined based on user configurable parameters. For example, the size of the third region may be determined based on a number of pixels selected to be from each of the foreground and background portion. In one example, a user may configure the third region to include zero pixels from the foreground region 110, and twenty-four pixels from the background region 115, where the twenty-four pixels are counted in a linear and perpendicular row from where the foreground region 110 ends. In this example, a third region of pixels that is twenty-four pixels in width will be generated directly adjacent to the foreground region 110, surrounding the outside boundaries of the foreground region 110.

Still referring to FIG. 4, the background subtraction module 435 may produce at least two video data signals 605, 610. Each of the video data signals 605, 610 may contain the segmented frames. For example, the first data signal 605 may include, (1) the frames that contain only background pixels, and (2) frames that include only foreground pixels of the first video camera data 495. The second data signal 610 may include, (1) the frames that contain only background pixels, and (2) frames that include only foreground pixels of the second video camera data 490. In an alternative embodiment, the first video data signal 605 may include the segmented background frames of both the video camera data 495, 490, and the second video data signal 610 may include the segmented foreground frames of both the video camera data 495, 490.

The background video feed may be transmitted or streamed at a slower rate relative to the foreground video feed to reduce bandwidth of the video streaming pipeline. The processor 415 may determine the rate at which the two video feeds are streamed via the network 445. For example, the processor may transmit the foreground video data signal at a rate that allows for live viewing of the video content (for example, 60 fps), while transmitting the background at a slower rate. In one embodiment, the live streaming system 400 may receive requests, via the network interface 420, setting the transmit rate of either the foreground or background video feeds. In another embodiment, the background video data may be transmitted once. For example, a single background frame may be transmitted once, while the foreground frames may be transmitted at a continuous rate. In such an example, the background remains a static image whereupon the foreground frames are overlaid.

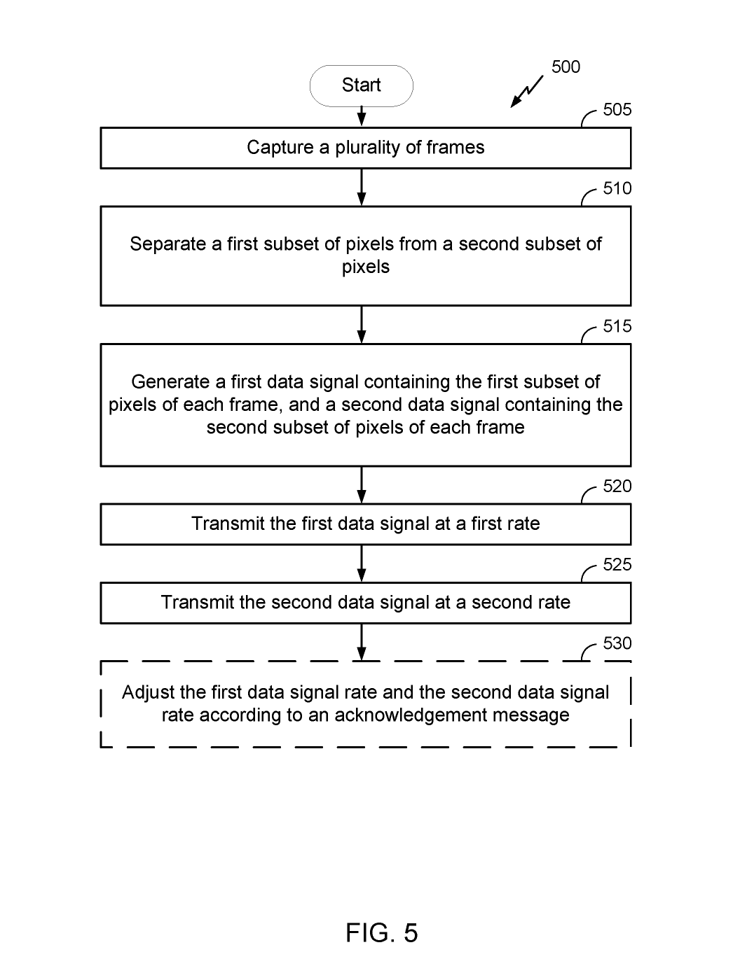

FIG. 5 is a flow chart illustrating an example method or process 500 for separating a live video by foreground and background pixels into two video data signals, and transmitting the two video data signals 605, 610 to a video combination implementation 600 designed to operate on a processor-based virtual reality headset 150. In step 505, the live streaming system 400 generates a plurality of stereoscopic video frames using at least two video cameras 405, 410. In step 510, the live streaming system 400 segments, portions, or separates a first subset of pixels from a second subset of pixels in each of the generated frames. The first subset of pixels may represent a foreground region 110 of the scene 100, while the second subset may represent the remaining pixels, or the background region 115 of the scene. The foreground pixels may be subtracted from the frames using foreground detection algorithms. The foreground region 110 and the background regions 115 may be determined based on a motion detection algorithm. For example, the motion detection algorithm may determine pixels in each frame that exhibit a degree of movement by performing edge detection and comparing the location of the edges in previous and/or subsequent frames. In one embodiment, the motion of an object may be detected by obtaining a plurality of images of an object over a period of time, identifying the object, and calculating gradients of movement of the object based on the plurality of images. The motion detection algorithm may also detect movement based on blur detection in the image. In one embodiment, the foreground region 110 of the scene may be separated from the background region 115 using a Gaussian model-based foreground and background segmentation. For example, the a Gaussian model-based foreground and background segmentation may be used to detect object movement and also for foreground and background segmentation or separation into two data signals.

Still referring to FIG. 5, in step 515, the live streaming system 400 generates two video data signals. A first video data signal may contain a stereoscopic pair of foreground frames generated by the two video cameras 405, 410, and a second video data signal may contain a stereoscopic pair of background frames generated by the two video cameras 405, 410. In step 520, the first data signal may be transmitted at a first frame rate. In step 525, the second data signal may be transmitted at a second frame rate. The frame rate of each of the first and second data signals may vary from each other, and may further vary based on video size, signal strength, network type, etc. In optional step 530, the processor 415 may adjust the frame rate and the refresh rate of the first data signal and/or the second data signal, the adjustment made according to a request from the virtual reality headset 150. For example, the headset 150 may detect a delta in the brightness, color, or sharpness between the overlapping pixels of the foreground and background being displayed in the headset 150, and may request a faster refresh rate of the background frames.

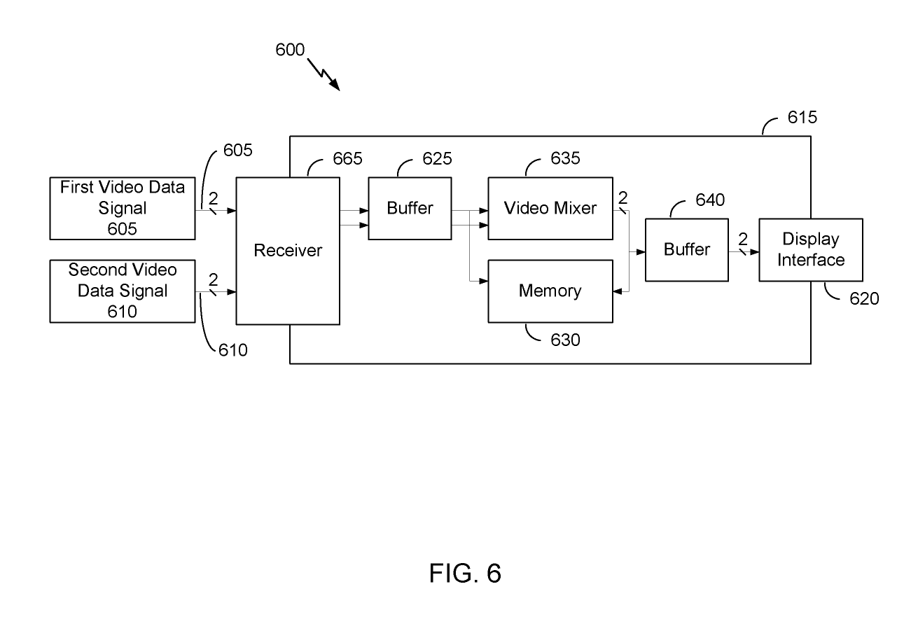

FIG. 6 illustrates an example video combiner 600 designed to operate on a processor-based virtual reality headset 150. The video data signals 605, 610 may be received via a wireless or wired network connection. A transceiver 665 may include a transceiver for transmitting and receiving wireless data. The transceiver 665 may be functionally and physically integrated with the processor 615. In another embodiment, the receiver may be a wired connection such as an HDMI receptacle, although other analog and digital video connectors such as VGA, DisplayPort, HDBaseT, CoaXPress, and Mobile High-Definition Link (MHL) connections are contemplated. The transceiver 665 may receive two video data signals 605, 610, wherein each video data signal contains at least two subset video data signals. For example, a first subset video data signal of the first video data signal 605 may contain only the foreground pixels captured by the first video camera 405, while a second subset video data signal of the second video data signal 605 may contain only the background pixels captured by the first video camera 405. In another example, a first subset video data signal of the second video data signal 610 may contain only the foreground pixels captured by the second camera 410, while a second subset video data signal of the second video data signal 610 may contain only the background pixels captured by the second camera 410.

One or more buffers 625 may be used for each video data signal 605, 610 in addition to, or in lieu of a memory 630. The buffer 625 may be implemented as temporary storage for the received video data signals 605, 610 during processing. The processor 615 may perform a video mixing algorithm 635 to combine the foreground and background portions of each video data signal, and output the combined video data signals to a display. For example, the video mixing algorithm 635 may combine the foreground portion and the background portion of the first video data signal 605, and output a combined video data signal. The video mixing algorithm may also combine the foreground portion and the background portion of the second video data signal 610. The processor may store the combined video frames in the memory 630. A second buffer 640 may also be used to temporarily hold the combined video frames output by the video mixer. A display interface 620 may be functionally and/or physically coupled to a display device on a virtual reality headset 150. For example, the display interface 620 may be a wired interface between the transceiver 600 and the virtual reality headset 150, or in the alternative, the display interface 620 may include a wireless interface with the virtual reality headset 150.

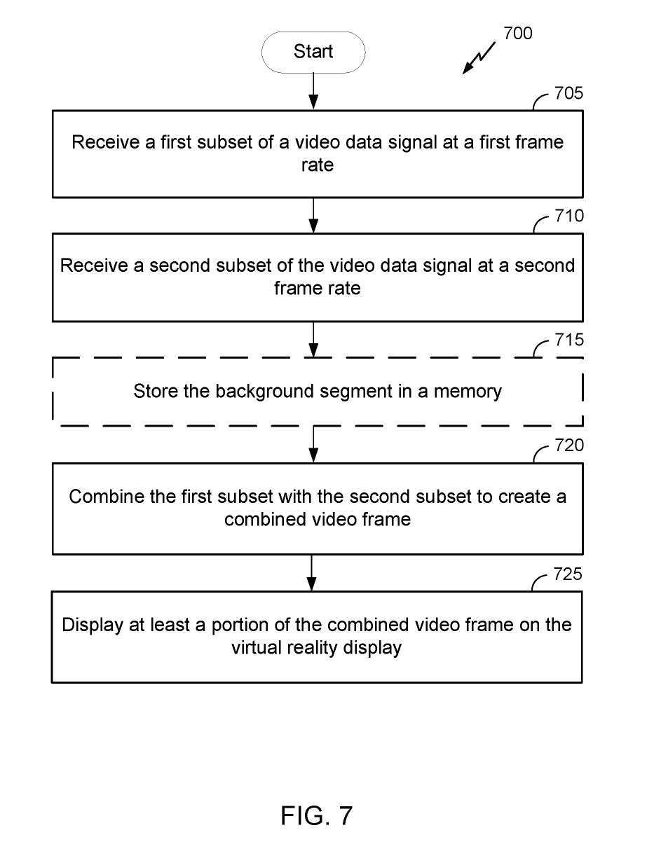

FIG. 7 is a flow chart illustrating an example method or process 700 for combining two received video frames, where each video frame contains a foreground portion and a background portion, respectively, of the scene captured by a camera. In step 705, the video combiner 600 receives a foreground portion of a live video feed at a first frame rate from each camera of the at least one stereoscopic pair of cameras, where the foreground portion comprises a first portion of a scene captured by each camera. In step 710, the video combiner 600 may receive a foreground portion of a live video feed at a first frame rate from each camera of the at least one stereoscopic pair of cameras, wherein the foreground portion comprises a first portion of a scene captured by each camera. In optional step 715, the video combiner 600 may store the received background portion in a memory. The video combiner 600 may store a number of received background portions in the memory according to the time each portion is received. In such an embodiment, the background portions stored in the memory may be refreshed as new background portions are received. In step 720, the video combiner 600 may combine the received foreground portion with the stored background portion to create a video frame that includes both the portions in a single frame. The video mixer 635 may generate the combined video frame. In step 725, the processor may cause at least a portion of the combined video frame to be displayed on a virtual reality display.

In one embodiment, the two video data signals 605, 610 each include a foreground portion and a background portion, where the foreground and background portions of each video data signal are received at different rates. In one example, the background frames of the first video data signal 605 may be received at a rate of 1 frame per second (fps), while the foreground frames of the first video data signal 605 may be received at a rate of 60 fps. In such an embodiment, the bandwidth required for transmitting, or streaming, the live video content from the live streaming system 400 to the video combiner 600 operating on the virtual reality headset 150 may be significantly reduced. Each received background frame may be stored in the memory 630, and may be used to create a series of combined video frames at the rate at which the foreground portions are received (e.g., 60 fps). Hence, the video frames output by the video mixer 635 may be output at the same rate that the foreground portions are received, where the same background portion is used in the output of any number of frames output by the video mixer 635.

In one embodiment, the background portion 115 may be pre-recorded prior to recording a scene that contains a foreground portion 110. In this embodiment, the background portion 115 may be pre-loaded or stored on the video combiner 600 to be combined with the live streaming foreground portion 110. This embodiment eliminates the need for a background portion 115 to be transmitted to the video combiner, further reducing bandwidth requirements. In another embodiment, the pre-loaded or transmitted background portion 115 may be a static image or a length of video that can be stored in the memory 630 and played on a continuous loop with the live foreground portion 110. In another embodiment, the foreground portion 110 and the background portion 115 may be determined based on the camera configuration. For example, the camera system 105 may include multiple sets of stereoscopic cameras pointing in different directions in order to capture a full or substantial spherical and 360 degree view. One pair of stereoscopic cameras may be configured to capture the foreground portion 110, while the remaining cameras capture the background portion 115. In this configuration, there may be no need to separate pixels from the captured frames because the entire frame of each camera is either a background frame or a foreground frame.

The video combiner 600 may send a request to the live streaming system 400 to update the rate at which the background frames are sent by the live streaming system 400 to the video combiner 600 operating on the virtual reality headset 150. For example, a user may adjust the rate at which the background frames of each video data signal 605, 610 are received. The user may increase the rate of transmission of the background portions to match the rate at which the foreground portions are transmitted. Alternatively, the user may decrease the rate at which the background portions are transmitted, or pause their transmission completely. In such a case, the video mixer 635 may reuse the most recently received background frame for each frame that it combined and outputs. For example, the video mixer 635 may combine the foreground portions received at a 60 fps rate with a background portion stored in the memory 630, resulting in a video feed that includes a live streaming foreground element and a reused background element presented stereoscopically. In this example, each frame output by the video combiner may be a combination of a static background portion, or image, and a foreground portion.

In one embodiment, the live streaming system 400 may update the rate at which either the foreground video data signal or the background video data signal, or both, are sent to the video combiner 600. The update may be based on the quality of service (QoS) of the network connection between the live streaming system 400 and the video combiner 600. The QoS of the network connection may include several parameters of the network service such as error rates, bit rate, throughput, transmission delay, availability, jitter, etc. The processor 415 may determine an optimal transmission rate of each of the foreground and background video feeds 505, 510, and may use the buffers 440, 450 to hold frames and adjust the data rate. The processor 415 may also give priority to the foreground video feed transmission rate over the background video feed transmission rate. In this embodiment, transmission of the background video feed may be reduced or paused to dedicate transmission of the foreground video feed.

In one embodiment, when the user increases the rate at which the video data signal containing the background frames are received to match the rate at which the video data signal containing the foreground frames are received, the processor 415 of the live streaming system 400 may disable the background subtraction module 435 and transmit the stereoscopic video feeds 405, 410 to the virtual reality headset without separating the background and foreground pixels of each frame. In such a case, the video mixer 635 of the video combiner 600 may also be disabled to the extent that a recombination of foreground and background pixels is required. The video mixer may still operate to create a video feed that contains the video frames of multiple cameras to create a 360 degree field of view in a video data signal.

In one embodiment, the foreground portion of each video data signal 605, 610 may contain only the foreground pixels as determined by the background subtraction module 435, whereas the background portion of each video data signal 605, 610 may contain only the background pixels as determined by the background subtraction module 435. In an alternative embodiment, the foreground portion may include a region of pixels from the background portion. The region of pixels may include pixels in the background portion that are adjacent to, and surrounding the foreground pixels. In some embodiments, the processor 615 may compare the region of pixels in the foreground portion with the same region of pixels in the background portion before combining the two portions. In the comparison, the processor 615 may determine differences in image parameters of the pixels. The image parameters may include, but are not limited to, brightness, contrast, sharpness, hue, shade, tint, chrominance values, and luminance values of the region of pixels. A user configurable threshold value may be set to indicate a maximum allowable difference of the image parameters between the region of pixels in the foreground portion and the same region of pixels in the background portion. If the user configurable threshold is exceeded, then the processor 615 may request, via a transceiver 665, that the latest background portion of the first video data signal 605 and/or the second video data signal 610 be transmitted to the video combination implementation. In another embodiment, the rate at which the background portion is received for each of the video data signals 605, 610 may be increased. The rate of receiving a background portion for one of the video data signals may vary with respect to the rate of receiving the other background portions associated with other video data signals.

The region of pixels in the foreground portion that include a region of pixels from the background portion may be used to align the foreground portion with the background portion when combining the two portions.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

As used herein, a wireless interface may refer to any wireless video and/or audio connection including, but not limited to, Bluetooth, Wi-Fi, and Wireless Home Digital Interface (WHDI).

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal®, or Java®, and ran under a conventional operating system. C, C++, BASIC, Pascal, Java®, and FORTRAN are industry standard programming languages for which many commercial compilers can be used to create executable code. The system may also be written using interpreted languages such as Perl®, Python®, or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for displaying a composite of a live video and a background video on a virtual reality display, the method comprising:
receiving a first subset of a video data signal, the first subset of the video data signal comprising a first portion of a scene captured by at least one stereoscopic pair of cameras;
receiving a second subset of the video data signal, the second subset of the video data signal comprising a second portion of the scene;
combining, via a processor, the first subset with the second subset to create a combined video frame; and
displaying at least a section of the combined video frame on the virtual reality display.

2. The method of claim 1, wherein the first subset is the live video of the scene and the second subset is the background video of the scene.

3. The method of claim 2, wherein the background video includes a panoramic view of the scene and the live video is a foreground portion of the scene.

4. The method of claim 1, wherein the first subset comprises a first set of pixels associated with the live video of the scene, and wherein the second subset comprises a second set of pixels associated with the background video of the scene.

5. The method of claim 4, wherein the first set of pixels is determined based on at least one of:
manual selection of a portion of the scene being captured by each camera of the at least one stereoscopic pair of cameras; and
a motion detection algorithm.

6. The method of claim 4, wherein combining the first subset with the second subset comprises the first set of pixels being overlaid with at least a portion of the second set of pixels.

7. The method of claim 1, wherein the first subset is received at a first frame rate and the second subset is received at a second frame rate, the second frame rate being different from the first frame rate.

8. The method of claim 7, further comprising:
determining a difference in image parameters between the first subset and the second subset, wherein the determination comprises comparing the image parameters of the first subset with the second subset; and
adjusting the second frame rate when the difference in the image parameters is greater than a threshold value.

9. The method of claim 8, wherein the image parameters comprise at least one of:
a brightness of the image;
a contrast of the image;
a sharpness of the image; and
a color of the image, wherein the color comprises a hue, shade, tint, and a luminosity value.

10. The method of claim 8, wherein adjusting the second frame rate is user configurable.

11. An system for displaying live video on a virtual reality display, comprising:
a transceiver;
a first processor, configured to:
receive, via the transceiver, a first subset of a video data signal at a first frame rate from a video data transmitter, wherein the first subset comprises a first portion of a scene captured by at least one stereoscopic pair of cameras,
receive, via the transceiver, a second subset of the video data signal at a second frame rate from the video data transmitter, wherein the second subset comprises a second portion of the scene, storing the second subset in a memory, and
combine the first subset with the second subset to create a combined video frame; and
a stereoscopic display operably coupled to the processor and configured to display at least a section of the combined video frame.

12. The system of claim 11, further comprising the video data transmitter, the video data transmitter comprising:
the at least one stereoscopic pair of cameras configured to capture the scene;
a second processor configured to:
generate the video data signal, wherein the video data signal comprises the captured scene;
generate the first subset and the second subset by separating regions of pixels of the video data signal;
transmit the first subset at the first frame rate; and
transmit the second subset at the second frame rate.

13. The system of claim 11, further comprising receiving a third subset of pixels, the third subset of pixels being a region of pixels including pixels from both the first subset and the second subset, wherein the region of pixels comprises at least a number of pixels of the first subset and the second subset that are directly adjacent, and wherein the third subset of pixels are received at the first frame rate.

14. The system of claim 13, wherein the number of pixels of the third subset of pixels is determined based on at least one of:
manual selection of an area of the scene being captured by each camera of the at least one stereoscopic pair of cameras; and
a motion detection algorithm.

15. The system of claim 11, wherein combining the first subset with the second subset comprises overlaying the first subset with at least a portion of the second subset.

16. The system of claim 11, further comprising:
determining a difference in image parameters between the first subset and the second subset, wherein the determination comprises comparing the image parameters of the first subset with the second subset; and
adjusting the second frame rate when the difference in the image parameters is greater than a threshold value.

17. The system of claim 16, wherein the image parameters comprise at least one of:
a brightness of the image,
a contrast of the image,
a sharpness of the image, and
a color of the image, wherein the color comprises a hue, shade, tint, and a luminosity value.

18. A non-transitory, computer readable medium comprising instructions that when executed cause a processor in a device to:
receive, via a transceiver, a first subset of a video data signal at a first frame rate from a video data transmitter, wherein the first subset comprises a first portion of a scene captured by at least one stereoscopic pair of cameras,
receive, via the transceiver, a second subset of the video data signal at a second frame rate from the video data transmitter, wherein the second subset comprises a second portion of the scene,
combine the first subset with the second subset to create a combined video frame, and
display, via a stereoscopic display operably coupled to the processor, at least a section of the combined video frame.

19. The non-transitory, computer readable medium of claim 18, further comprising the video data transmitter, the video data transmitter comprising:
the at least one stereoscopic pair of cameras configured to capture the scene;
a second processor configured to:
generate the video data signal, wherein the video data signal comprises the captured scene;
generate the first subset and the second subset by separating regions of pixels of the video data signal;
transmit the first subset at the first frame rate; and
transmit the second subset at the second frame rate.

20. The non-transitory, computer readable medium of claim 18, further comprising receiving a third subset of pixels, the third subset of pixels being a region of pixels including pixels from both the first subset and the second subset, wherein the region of pixels comprises at least a number of pixels of the first subset and the second subset that are directly adjacent.
